(19) United States
(12) Patent Application Publication
(10) Pub. No.: US 2025/0303609 A1
(43) Pub. Date: Oct. 2, 2025

(54) METHOD FOR MANUFACTURING ARTICLE AND POWDER MATERIAL

(71) Applicant: CANON KABUSHIKI KAISHA, Tokyo (JP)

(72) Inventors: RIKA COURQUIN, Tokyo (JP); TSUTOMU SHIMANO, Shizuoka (JP); SHOTA AMANO, Kanagawa (JP); MOTOKI OKINAKA, Tokyo (JP); YUTAKA ARAI, Kanagawa (JP)

(21) Appl. No.: 19/089,574

(22) Filed: Mar. 25, 2025

(30) Foreign Application Priority Data
Mar. 26, 2024 (JP) 2024-049551

(51) Int. Cl. B28B 1/00; B33Y 10/00; B33Y 70/00

(52) U.S. Cl. CPC B28B 1/001; B33Y 70/00; B33Y 10/00

(57) ABSTRACT

A method for manufacturing an article containing silicon carbide as a main component includes a step of forming a layer of a raw material powder and a step of irradiating the layer of the raw material powder with a laser on the basis of data from a three-dimensional model, in which the steps are performed multiple times, the raw material powder contains silicon carbide particles having a particle size larger than 200 nm and metallic silicon particles having a particle size larger than 200 nm, and the metallic silicon particles have a number-average particle size smaller than a number-average particle size of the silicon carbide particles.

### BACKGROUND

### Field of the Disclosure

The present disclosure relates to a method for manufacturing an article and a powder material.

### Description of the Related Art

To manufacture articles with complex shapes and articles of a wide variety in small lots, three-dimensional (3D) printing, an additive manufacturing method that manufactures any desired shape on the basis of a three-dimensional model of an article to be produced is increasingly used. Furthermore, recent years have seen attempts to use the additive manufacturing method in manufacturing articles composed of inorganic compound materials, such as silicon carbide and TiAl, that are difficult to process. Known examples of the additive manufacturing method for manufacturing articles containing silicon carbide as a main component include a powder bed fusion method, a binder jetting method, a vat photo polymerization method, and a directed energy deposition method.

Of these, the powder bed fusion method manufactures an article by repeating multiple times a step of forming a layer of a raw material powder on a manufacturing surface and a step of irradiating the layer of the raw material powder with a laser on the basis of data from a three-dimensional model so as to generate a melt of the raw material powder and solidifying the generated melt to form a fused layer.

Japanese Patent Laid-Open No. 2021-102548 indicates that a powder mixture of a silicon carbide powder, a metallic silicon powder, and a carbon powder is used as the raw material powder used in manufacturing an article containing silicon carbide as a main component by the powder bed fusion method.

Journal of the European Ceramic Society, Volume 38, Issue 11, 3709-3717 (2018), discloses an article manufacturing method that involves irradiating a powder containing silicon carbide and metallic silicon with a laser and fusing the raw material powder with molten metallic silicon.

However, in both Japanese Patent Laid-Open No. 2021-102548 and Journal of the European Ceramic Society, Volume 38, Issue 11, 3709-3717 (2018) disclosed above, the average particle size of the metallic silicon powder in the raw material powder is large relative to the average particle size of the silicon carbide powder. Thus, the metallic silicon powder is likely to cause laser scattering, and the laser may not be transmitted to the lower part of the layer. As a result, the metallic silicon in the lower part of the layer may not melt sufficiently, delamination may occur, and the resulting article may have insufficient strength.

### SUMMARY OF THE DISCLOSURE

The present disclosure provides a technology that provides advantages in manufacturing articles having excellent strength.

There is provided a method for manufacturing an article containing silicon carbide as a main component according to an aspect of the present disclosure that includes a step of forming a layer of a raw material powder and a step of irradiating the layer of the raw material powder with a laser on the basis of data from a three-dimensional model, in which the steps are performed multiple times, the raw material powder contains silicon carbide particles having a particle size larger than 200 nm and metallic silicon particles having a particle size larger than 200 nm, and the metallic silicon particles have a number-average particle size smaller than a number-average particle size of the silicon carbide particles.

A first powder material according to an aspect of the present disclosure is a powder material for use in a powder bed fusion method or a binder jetting method, the powder material containing silicon carbide particles having a particle size larger than 200 nm and metallic silicon particles having a particle size larger than 200 nm, in which the metallic silicon particles have a number-average particle size smaller than a number-average particle size of the silicon carbide particles.

A second powder material according to an aspect of the present disclosure is a powder material containing silicon carbide particles having a particle size larger than 200 nm, metallic silicon particles having a particle size larger than 200 nm, and inorganic material particles that satisfy at least one of having a particle size of 200 nm or less and being composed of an inorganic material other than silicon carbide and metallic silicon, in which the metallic silicon particles have a number-average particle size smaller than a number-average particle size of the silicon carbide particles, the inorganic material constituting the inorganic material particles is an inorganic oxide, an inorganic nitride, or an inorganic carbide, and a volume fraction of the inorganic material particles relative to the powder material is 0.01 vol % or more and 4.00 vol % or less.

Further features of the present disclosure will become apparent from the following description of exemplary embodiments with reference to the attached drawings.

### BRIEF DESCRIPTION OF THE DRAWINGS

FIGS. 1A to 1C are schematic diagrams illustrating the relationship between the raw material powder and the laser transmittance.

FIGS. 2A to 2H are diagrams illustrating one example of a method for manufacturing an article.

FIGS. 3A to 3D are diagrams illustrating an article as a sample for evaluating delamination.

### DESCRIPTION OF THE EMBODIMENTS

The technology according to the present disclosure will now be described in detail through embodiments.

### Raw Material Powder (Powder Material)

The powder bed fusion method manufactures an article by repeating multiple times a step of forming a raw material powder layer on a manufacturing surface and a step of irradiating the raw material powder layer with a laser on the basis of data from a three-dimensional model so as to generate a melt of the raw material powder and solidifying the generated melt to form a fused layer. Thus, the raw material powder is required to have properties such as an ability to form a homogeneous raw material powder layer and an ability to generate a melt at the entire site irradiated with the laser. Here, in this embodiment, the “manufacturing surface” refers to a surface on which a new raw material powder layer is to be formed.

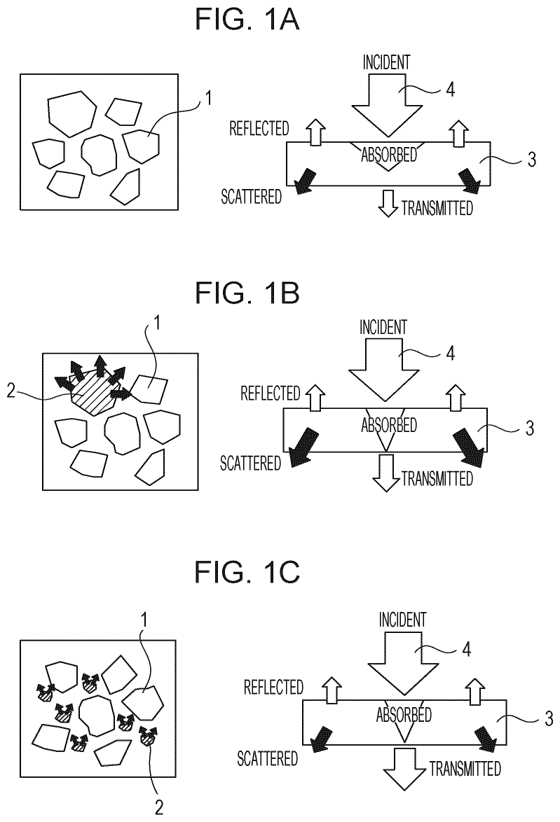

FIGS. 1A to 1C are schematic diagrams illustrating the relationship between the raw material powder and the laser transmittance. In FIGS. 1A to 1C, reference sign 1 denotes silicon carbide particles, 2 denotes metallic silicon particles, 3 denotes a raw material powder layer, and 4 denotes a laser. As indicated by arrows in FIGS. 1A to 1C, the laser 4 incident on the raw material powder layer 3 is absorbed, reflected, scattered, or transmitted.

In FIGS. 1A to 1C, scattering is indicated by black arrows.

Silicon carbide (SiC) is known to have a high laser absorbance. Thus, as illustrated in FIG. 1A, when a raw material powder containing only silicon carbide particles 1 is used, the laser 4 is rarely transmitted to the lower part of the raw material powder layer 3, and thus it is extremely difficult to generate a melt of the raw material powder in the lower part of the raw material powder layer 3. Since sufficient bonding does not occur between layers at the site where the melt of the raw material powder could not be sufficiently generated, delamination, which is the phenomenon of separation between the layers, is likely to occur. Delamination increases voids in the article, and thus renders it difficult to manufacture an article having excellent strength.

As illustrated in FIG. 1B, when a raw material powder containing silicon carbide particles 1 and metallic silicon particles 2 is used, the laser 4 is smoothly transmitted to the lower part of the raw material powder layer 3 since metallic silicon (Si) having a lower laser absorbance than silicon carbide (SiC) is used. Meanwhile, as illustrated in FIG. 1B, when the metallic silicon particles 2 are larger than the silicon carbide particles 1, the metallic silicon particles 2 induce scattering of the laser 4. In such a case, the laser 4 is rarely transmitted to the lower part of the raw material powder layer 3, and it is difficult to generate a melt of the raw material powder in the lower part of the raw material powder layer 3; thus, it is difficult to reduce delamination and manufacture an article having excellent strength.

In this regard, the inventors of the present disclosure have succeeded in manufacturing an article containing silicon carbide as a main component and having less delamination and improved strength by proposing a raw material powder obtained by mixing silicon carbide particles 1 and metallic silicon particles 2 having a number-average particle size smaller than that of the silicon carbide particles 1. In this embodiment, the “main component” refers to a component that accounts for more than 50.00 vol % of the raw material powder or a component that is contained in the largest amount in the raw material powder.

Manufacturing an article by the manufacturing method of this embodiment will now be described. First, a raw material powder layer 3 is formed on a manufacturing surface and irradiated with a laser 4 on the basis of data from a three-dimensional model.

At the site irradiated with the laser 4, the silicon carbide particles 1 that have absorbed the laser 4 become heated. Silicon carbide is a material that is pyrolyzed into silicon and carbon at 2,830° C. or higher and sublimed at a temperature near 3,600° C., and has no temperature range corresponding to the liquid phase. Thus, by heating silicon carbide in the temperature range of 2,800° C. or higher and lower than 3,600° C., silicon carbide can be pyrolyzed and a melt of silicon or carbon can be obtained. A melt of silicon or carbon functions as a binder and generates a fused layer. Eventually, an article is manufactured by repeating multiple times a step of forming a raw material powder layer 3 and a step of irradiating the raw material powder layer 3 with a laser 4 to form a fused layer.

By mixing the metallic silicon particles 2 having a lower absorbance for the laser 4 than the silicon carbide particles 1 in the raw material powder, the laser 4 is smoothly transmitted to the lower part of the raw material powder layer 3 and the fusion of the raw material powder is smoothly induced throughout the layer. Generally speaking, the intensity of the scattered light tends to increase with the size of the particles, and it becomes difficult for the laser to be transmitted to the lower part of the raw material powder layer 3. Thus, in this embodiment, as illustrated in FIG. 1C, scattering of the laser 4 by the metallic silicon particles 2 is reduced by using the metallic silicon particles 2 having a smaller number-average particle size than the silicon carbide particles 1. As a result, the laser 4 is more smoothly transmitted to the lower part of the raw material powder layer 3, and a melt of silicon or carbon can be sufficiently generated in the lower part of the layer. As a result, the layers can be sufficiently bonded together, delamination can be decreased, and the strength of the article containing silicon carbide as a main component can be improved. Another reason for selecting metallic silicon as the material to be mixed with silicon carbide is that, in the process after the manufacture of the article, metallic silicon can be reacted with carbon to form silicon carbide, and thus the properties derived from silicon carbide can be easily imparted to the article.

### First Raw Material Powder (Powder Material)

A first raw material powder is a powder used in the powder bed fusion method or the binder jetting method and contains silicon carbide particles having a particle size larger than 200 nm and metallic silicon particles having a particle size larger than 200 nm, in which the number-average particle size of the metallic silicon particles is smaller than the number-average particle size of the silicon carbide particles.

The first raw material powder can be used in not only the powder bed fusion method but in other additive manufacturing methods such as the binder jetting method. This is because the powder bed fusion method and the binder jetting method are both a manufacturing method in which a step of conveying a raw material powder with a roller, a squeegee, or the like to form a raw material powder layer and a step of fusing a desired site of the raw material powder layer on the basis of the data from a three-dimensional model are performed multiple times.

### Silicon Carbide Particles Having Particle Size Larger Than 200 nm

The number-average particle size of the silicon carbide particles having particle size larger than 200 nm is can be 2.0 μm or more and 200.0 μm or less, or can be 15.0 μm or more and 50.0 μm or less.

When the number-average particle size of the silicon carbide particles is 2.0 μm or more and 200.0 μm or less, the influence of the force of gravity on the adhesive force between the particles increases; thus, it becomes possible to reduce aggregation of the silicon carbide particles and obtain flowability suitable for forming a homogeneous raw material powder layer. In addition, since the crystal grain size of the article decreases, propagation of microcracks inside the article is inhibited. Thus, it becomes possible to manufacture an article having excellent strength.

The aspect ratio of the silicon carbide powder having a particle size larger than 200 nm may be 0.60 or more and 1.00 or less. When the aspect ratio of the silicon carbide particles is 0.60 or more and 1.00 or less, the contact area between the silicon carbide particles and other particles decreases, and flowability suitable for forming a homogeneous raw material powder layer can be obtained. Since the raw material powder packing properties are improved, it becomes possible to manufacture an article having excellent strength.

The aspect ratio of the silicon carbide particles having a particle size larger than 200 nm may be larger than the aspect ratio of the metallic silicon particles having a particle size larger than 200 nm. When the aspect ratios of the silicon carbide particles and the metallic silicon particles satisfy this requirement, the contact area between the silicon carbide particles and other particles decreases, and flowability suitable for forming a homogeneous raw material powder layer can be obtained. In addition, since the raw material powder packing properties are improved, it becomes possible to manufacture an article having excellent strength.

The amount of the silicon carbide particles having a particle size larger than 200 nm in terms of volume fraction with respect to the raw material powder can be 55.00 vol % or more and 95.00 vol % or less or can be 75.00 vol % or more and 95.00 vol % or less. When the volume fraction of the silicon carbide particles is 55.00 vol % or more and 95.00 vol % or less, the properties derived from silicon carbide can be easily imparted to the article. Furthermore, the effect of the metallic silicon particles of inducing the laser to be transmitted to the lower part of the raw material powder layer can be sufficiently exhibited, delamination can be decreased, and an article having excellent strength can be manufactured.

### Metallic Silicon Particles Having Particle Size Larger Than 200 nm

The ratio of the number-average particle size of the metallic silicon particles having a particle size larger than 200 nm to the number-average particle size of the silicon carbide particles having a particle size larger than 200 nm (metallic silicon particles/silicon carbide particles) can be 0.005 or more and 0.950 or less, or can be 0.020 or more and 0.800 or less, or can be 0.020 or more and 0.600 or less. When the number-average particle size ratio (metallic silicon particles/silicon carbide particles) is 0.005 or more and 0.950 or less, aggregation of the metallic silicon particles can be prevented, and flowability suitable for forming a homogeneous raw material powder layer can be obtained.

Furthermore, the scattering of the laser by the metallic silicon particles is reduced, and the laser is more easily transmitted to the lower part of the raw material powder layer. Thus, it becomes possible to reduce delamination and manufacture an article having excellent strength.

The amount of the metallic silicon particles having a particle size larger than 200 nm contained in terms of volume fraction with respect to the raw material powder can be 5.00 vol % or more and 45.00 vol % or less or can be 5.00 vol % or more and 25.00 vol % or less when the raw material powder does not contain inorganic material particles that satisfy at least one of having a particle size of 200 nm or less and being composed of an inorganic material other than silicon carbide and metallic silicon. The amount of the metallic silicon particles having a particle size larger than 200 nm contained in terms of volume fraction with respect to the raw material powder can be 1.00 vol % or more and 44.99 vol % or less or can be 5.00 vol % or more and 24.99 vol % or less when the raw material powder contains inorganic material particles that satisfy at least one of having a particle size of 200 nm or less and being composed of an inorganic material other than silicon carbide and metallic silicon. When the volume fraction of the metallic silicon particles is within this range, the properties derived from silicon carbide can be easily imparted to the article. Furthermore, the effect of the metallic silicon particles of inducing the laser to be transmitted to the lower part of the raw material powder layer can be sufficiently exhibited, delamination can be decreased, and an article having excellent strength can be manufactured.

### Other Inorganic Material Particles

The first raw material powder may contain other inorganic material particles, i.e., inorganic material particles that satisfy at least one of having a particle size of 200 nm or less and being composed of an inorganic material other than silicon carbide and metallic silicon. Hereinafter, inorganic material particles that are neither silicon carbide particles having a particle size larger than 200 nm nor metallic silicon particles having a particle size larger than 200 nm may be simply referred to as “inorganic material particles”. When inorganic material particles having a particle size of 200 nm or less adhere to some part of the surfaces of the particles having a particle size larger than 200 nm in the raw material powder, the contact area between the particles in the raw material powder can be decreased, and the frictional force generated between the particles can be decreased. When the frictional force generated between particles decreases, the flowability of the raw material powder improves, and thus it becomes possible to form a homogeneous raw material powder layer and mix powders of different specific gravities to homogeneity, such as silicon carbide particles and metallic silicon particles. As such, the inorganic material particles having a particle size of 200 nm or less can appropriately function as a fluidizer that improves the flowability.

Specifically, another reason why inorganic material particles having a particle size of 200 nm or less may adhere to some part of the surfaces of the silicon carbide particles is presumably as follows. That is, in the manufacturing method that involves local laser irradiation such as a powder bed fusion method, the raw material powder may be rapidly heated and cooled in some instances, and microcracks are likely to occur in the article due to the heat stress. To address this, inorganic material particles having a particle size of 200 nm or less are adhered to at least some part of the silicon carbide particle surfaces so that, when the silicon carbide particles absorb the laser and generate heat, heat conduction to the periphery is decreased due to the presence of the inorganic material particles, and thus rapid heating of the raw material powder can be suppressed. As a result, it becomes possible to decrease occurrence of microcracks in the article and manufacture an article having excellent strength.

The inorganic material particles may have a number-average particle size of 3 nm or more and 200 nm or less. The inorganic material particles having a number-average particle size of 3 nm or more and 200 nm or less include inorganic material particles having a particle size of 200 nm or less, and can include inorganic material particles composed of an inorganic material other than silicon carbide and metallic silicon and having a particle size of 200 nm or more. When the inorganic material particles have a number-average particle size of 3 nm or more and 200 nm or less, aggregation of the inorganic material particles can be prevented, and a homogeneous dispersed state can be created when mixed with silicon carbide particles. Furthermore, liberation of the inorganic material particles from the surfaces of the silicon carbide particles is prevented, and improvement in flowability of the raw material powder and improvement in strength of the article due to heat insulation can also be expected.

The aspect ratio of the inorganic material particles may be 0.85 or more and 1.00 or less. When the aspect ratio of the inorganic material particles is 0.85 or more and 1.00 or less, the contact area between the inorganic material particles and other particles is decreased, and the dispersibility of the inorganic material particles is improved due to the decrease in the frictional force between the particles. As a result, the flowability of the raw material powder can be improved.

The inorganic material that constitutes the inorganic material particles having a particle size of 200 nm or less is not particularly limited as long as the inorganic material improves the flowability of the raw material powder. The inorganic material that constitutes the inorganic material particles having a particle size of 200 nm or less may be silicon carbide or metallic silicon. However, in order to enhance the heat isolation effect upon heating of the silicon carbide particles, a material having a thermal conductivity lower than that of silicon carbide may be used. Examples of the material that satisfies such properties include inorganic oxides, inorganic nitrides, and inorganic carbides. More specific examples are SiO₂ and Al₂O₃.

The surfaces of the inorganic material particles may be hydrophobized. When a liquid bridge force generated by the moisture adhering to the particle surfaces acts between the particles of the silicon carbide particles and metallic silicon particles, the flowability of the raw material powder is degraded. Coating the surfaces of the silicon carbide particles with the surface-hydrophobized inorganic material particles weakens the liquid bridge force and can improve the flowability of the raw material powder.

The amount of the inorganic material particles contained relative to the raw material powder may be 0.01 vol % or more and 4.00 vol % or less. When the amount of the inorganic material particles contained is 0.01 vol % or more and 4.00 vol % or less, the flowability of the raw material powder can be sufficiently improved. This also prevents the silicon carbide particles from becoming excessively coated with the inorganic material particles. Thus, when the silicon carbide particles are heated by laser irradiation, it can be anticipated that the melt of silicon or carbon generated by pyrolysis of silicon carbide helps fuse the raw material powder. Furthermore, it becomes possible to prevent degradation of the flowability of the raw material powder caused by aggregation of excessive inorganic material particles.

It should be noted that the raw material powder may contain an organic material as organic material particles or as a coating that covers at least one of silicon carbide particles, metallic silicon particles, and inorganic material particles. The flowability of the raw material powder and the optical absorption characteristics of the raw material powder for the laser can be controlled by using the organic material. The amount of the organic material contained in the raw material powder in terms of the volume fraction relative to the raw material powder may be smaller than that of the silicon carbide particles and the metallic silicon particles, may be smaller than that of the inorganic material particles, may be less than 1.00 vol %, may be less than 0.1 vol %, and may be less than 0.01 vol %.

### Laser Transmittance

When the raw material powder layer is formed, the laser transmittance of the raw material powder layer may be 20.0% or more and 50.0% or less. When the laser transmittance is within this range, the laser can be sufficiently transmitted to the lower part of the material powder layer, delamination can be reduced, and an article having excellent strength can be manufactured. The laser transmittance can be determined by, for example, measuring the transmittance of a 40 μm-thick raw material powder layer for a laser having a wavelength of 1,060 nm

### Number-Average Particle Size

The number-average particle sizes of the silicon carbide particles, the metallic silicon particles, and the inorganic material particles can be evaluated by scanning electron microscope (SEM)-energy dispersive X-ray spectroscopy (EDX). Hereinafter, the “scanning electron microscope-energy dispersive X-ray spectroscopy” may be referred to as “SEM-EDX”.

Specifically, first, a portion of the raw material powder is taken as a sample, and silicon carbide particles, metallic silicon particles, and inorganic material particles are identified by EDX element mapping. Next, three secondary electron images are taken from each of the silicon carbide particles and the metallic silicon particles at an observation magnification of 200× and from the inorganic material particles at an observation magnification of 40,000×. All of the particles free of missing parts that are photographed in the obtained secondary electron images are the subject of the measurement. For each of the particles of the measurement subject, a long diameter and a short diameter are measured, and the average of the long diameter and the short diameter is assumed to be the primary particle size of each particle. This number-average of the primary particle size is assumed to be the number-average particle size of each of the silicon carbide particles, the metallic silicon particles, and the inorganic material particles.

### Aspect Ratio

The aspect ratios of the silicon carbide particles, the metallic silicon particles, and the inorganic material particles can be evaluated by SEM-EDX. Specifically, as with the number-average particle size, the long diameter and the short diameter are measured, and the value obtained by dividing the short diameter by the long diameter is assumed to be the aspect ratio of each particle. The average of the calculated aspect ratios is determined, and the result is assumed to be the aspect ratio of each of the silicon carbide particles, the metallic silicon particles, and the inorganic material particles. The closer the aspect ratio is to 1.0, the closer the shape of the particle to a sphere.

### Second Raw Material Powder (Powder Material)

The second raw material powder contains silicon carbide particles having a particle size larger than 200 nm, metallic silicon particles having a particle size larger than 200 nm, and inorganic material particles that satisfy at least one of having a particle size of 200 nm or less and being composed of an inorganic material other than silicon carbide and metallic silicon. In addition, the number-average particle size of the metallic silicon particles is smaller than the number-average particle size of the silicon carbide particles. Furthermore, the inorganic material that constitutes the inorganic material particles is an inorganic oxide, an inorganic nitride, or an inorganic carbide, and the volume fraction of the inorganic material particles relative to the raw material powder is 0.01 vol % or more and 4.00 vol % or less.

The inventors of the present disclosure have conducted studies on the method for manufacturing an article containing, as a main component, silicon carbide having excellent strength while reducing delamination. As a result, the inventors have found that, by adding, to the raw material powder, inorganic material particles that satisfy at least one of having a particle size of 200 nm or less and being composed of an inorganic material other than silicon carbide and metallic silicon, an unexpected effect can be exhibited in which particles of different specific gravities, such as silicon carbide and metallic silicon, can be mixed to homogeneity.

Such a raw material powder can be used in not only the powder bed fusion method but in other additive manufacturing methods such as the binder jetting method for the same reasons as that of the first raw material powder. According to these manufacturing methods, it is effective to prepare a raw material powder by mixing multiple types of particles to manufacture an article having desired properties. In doing to, how to mix particles having different specific gravities to homogeneity is critical.

Thus, the inventors have proposed the second raw material powder. As a result, the flowability of the raw material powder is improved, and the strength of an article containing silicon carbide as a main component is successfully improved. Furthermore, since metallic silicon particles having a number-average particle size smaller than that of the silicon carbide particles are contained, metallic silicon could be homogeneously dispersed in the article, the voids in the article could be effectively amended, and the strength of the article could be further improved.

The particles that constitute the second raw material powder are the same as those of the first raw material powder and thus detailed descriptions therefor are omitted.

### Method for Preparing Raw Material Powder

The method for preparing a raw material powder is not particularly limited, and, for example, a raw material powder may be prepared by mixing components by using a mixing device such as a V-type mixer, a ball mill, or a rocking mixer. From the viewpoints of the ability to efficiently disperse particles having different specific gravities and particle sizes from one another in a short mixing time and to reduce excessive impact on the particles, a V-type mixer may be used.

### Method for Manufacturing Article

The method for manufacturing an article according to an embodiment may be utilized as an additive manufacturing method that involves heating through laser irradiation. An article manufacturing process that uses an additive manufacturing method includes following steps (i) and (ii). According to the shape of the article to be manufactured, the steps (i) and (ii) are repeated.
(i) step of forming a raw material powder layer
(ii) step of irradiating the raw material powder layer with a laser on the basis of data from a three-dimensional model.

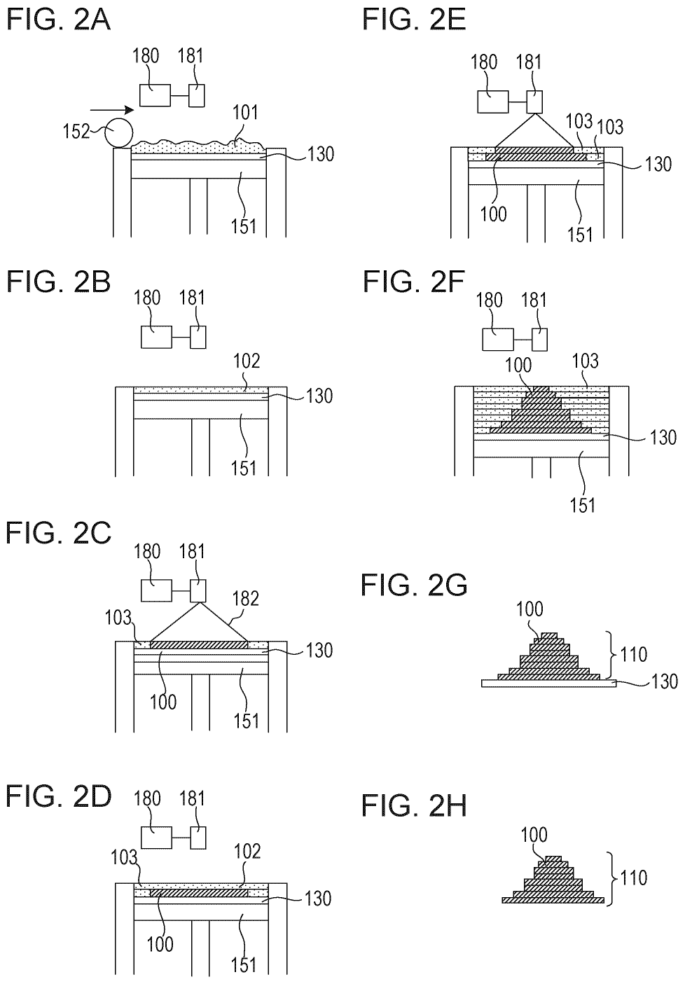

The case in which a powder bed fusion method is used will now be described as a specific example of the method for manufacturing an article with reference to FIGS. 2A to 2H.

First, as illustrated in FIGS. 2A and 2B, a raw material powder 101 is placed on a manufacturing surface of a platform 130 installed on a stage 151, and is leveled to a particular thickness with a roller 152.

The leveled raw material powder having the particular thickness is referred to as a raw material powder layer 102. The thickness of the raw material powder layer 102 affects the manufacturing accuracy and the manufacturing speed and thus may be 10 μm or more and 200 μm or less.

As illustrated in FIG. 2C, the surface of the raw material powder layer 102 is irradiated and with a laser emitted from a laser light source 180 while being scanned by a scanner unit 181 on the basis of the three-dimensional data of an article to be produced. A highly versatile YAG laser is often used as the laser light source 180; alternatively, a CO₂ laser, a semiconductor laser, or the like may also be used. The driving system may be a pulsed system or a continuous wave system. In a region 182 irradiated with the laser, the raw material powder 101 turns into a melt and then solidifies to form a fused layer 100.

Next, as illustrated in FIG. 2D, the stage 151 is moved downward, and a new raw material powder layer 102 is formed on the fused layer 100. As illustrated in FIG. 2E, the newly formed raw material powder layer 102 is irradiated with a laser as illustrated in FIG. 2C, to form a fused layer 100 in the irradiated range. At this stage, the output of the laser is adjusted so that the surface layer of the previously formed fused layer 100 on the side close to the newly formed raw material powder layer 102 turns into a melt; in this manner, the previously formed fused layer 100 and the subsequently formed fused layer 100 can be bonded together.

As illustrated in FIG. 2F, by repeating the series of steps, fused layers 100 formed layer-by-layer bond together to form an integral body, which is a manufactured article 110 of a desired shape. Lastly, as illustrated in FIGS. 2G and 2H, unfused powder 103 is removed, and, optionally, unnecessary portions of the manufactured article 110 are removed and the manufactured article 110 is detached from the platform 130 as necessary.

Furthermore, the inventors have conducted studies on the conditions under which a manufactured article can be stably formed by a powder bed fusion method using the raw material powder of this embodiment. In order to pyrolyze silicon carbide into silicon and carbon and control the decomposed silicon or carbon to form a melt, various parameters are investigated and the following findings have been gained.

As a method for controlling the laser irradiation energy, there are a method for controlling an in-plane energy density and a method for controlling a space energy density. The in-plane energy density is an irradiation intensity of a laser per unit area, and the unit is represented by J/mm². The space energy density is an irradiation intensity of a laser per unit volume, and is represented by J/mm³. As in the powder bed fusion method, when a manufactured article is to be formed by controlling the thickness of the raw material powder, it is appropriate to consider the space energy density. The space energy density JV is expressed by the following equation.

JV=W/(P×V×D)

where W represents the output power of the laser, P represents the irradiation pitch of the laser (scan interval), V represents the laser scanning rate, and D represents the thickness of the raw material powder layer 102. For a typical manufacturing apparatus, the laser power W can be adjusted within the range of 10 W or more and 1,000 W or less, the laser irradiation pitch P can be adjusted within the range of 5 μm or more and 500 μm or less, the laser scanning rate V can be adjusted within the range of 10 mm/sec or more and 10,000 mm/sec or less, and the thickness D of the raw material powder layer 102 can be adjusted within the range of 5 μm or more and 500 μm or less.

The space energy density JV can be controlled by setting the parameters W, P, V, and D using the aforementioned ranges as a guide. The space energy density JV may be 11 J/mm³ or more and 250 J/mm³ or less.

Furthermore, in order to form one manufactured article 110 by layering multiple fused layers 100, a previously formed fused layer 100 is to be bonded with a fused layer 100 formed next. In order to bond the fused layers 100 together, a melt of silicon or carbon may be generated by laser irradiation down to a lower portion of the fused layer 100 formed next. Such a state can also be realized by adjusting the thickness of the raw material powder layers 102 to be formed. According to the studies conducted by the inventors, the thickness of the raw material powder layer 102 at which a melt of silicon or carbon can be generated down to a lower portion of the fused layer 100 formed next is 5 μm or more and 200 μm or less although this may depend on the manufacturing conditions. The thickness of the raw material powder layer 102 is can be 20 μm or more and 75 μm or less.

### Post Process Step

The manufactured article prepared by the method of this embodiment includes voids inside, and thus impregnation may be conducted according to the usage to further improve the density. Examples of the known impregnation method include solid-phase impregnation, liquid-phase impregnation, and gas-phase impregnation; among these, solid-phase impregnation and liquid-phase impregnation increase the density of the manufactured article relatively easily and can increase the mechanical strength. In particular, solid-phase impregnation can improve the density in a short period of time.

When a manufactured article containing silicon carbide as a main component is to be subjected to solid-phase impregnation, void portions may be transformed into silicon carbide by first causing the voids inside the manufactured article to carry carbon and then causing the carbon to absorb molten metallic silicon. A specific procedure of the solid-phase impregnation includes, first, impregnating a manufactured article with a liquid-state resin and performing defoaming in vacuum to impregnate the voids with the liquid-state resin. After the unnecessary liquid-state resin on the surface of the manufactured article is removed, the resin is thermally cured and further heated to carbonization to cause the voids to support carbon. Next, the obtained manufactured article is brought into contact with molten metallic silicon in vacuum so as to impregnate the voids with metallic silicon, and then is heated at 1450° C. or higher and 1700° C. or lower, as a result of which the void portions can be transformed into silicon carbide. The degree of vacuum during metallic silicon impregnation can be 500 Pa or more and 50,000 Pa or less, or can be 1,000 Pa or more and 10,000 Pa or less, or can be 1,000 Pa or more and 5,000 Pa or less. After the void portions are transformed into silicon carbide, excess metallic silicon remains adhered to the surface of the manufactured article; however, this can be removed by a post process such as polishing and etching.

The resin used for the voids in the manufactured article to support carbon may be free of metal components. When metal components are contained, unnecessary silicide compounds may be generated by the reaction with metallic silicon in the manufactured article. Moreover, the higher the remaining carbon rate of the resin, the higher the silicon carbide rate of the void portions. The remaining carbon rate of the resin can be 50 wt % or more or can be 60 wt % or more, and a phenolic resin may be used. In order to cause the voids to be impregnated with the resin, the viscosity of the resin can be 1,000 m Pa·s or less or can be 500 mPads or less.

When liquid-phase impregnation is performed on a manufactured article of silicon carbide, a commercially available silicon carbide polymer (for example, “SMP-10” produced by Starfire Systems, Inc.) can be used as the impregnation material. The obtained manufactured article is immersed in a silicon carbide polymer solution and vacuum-defoamed to introduce the silicon carbide polymer solution into the voids inside the manufactured article. After the excess solution is removed from the surface of the manufactured article, heat treatment is performed in an inert gas at 400° C. or higher and 850° C. or lower to turn the silicon carbide polymer inorganic. The silicon carbide polymer is a silicon carbide ceramic precursor that contains organic matters, and about 30 wt % is lost by the heat treatment. Thus, by repeating the impregnation and the heat treatment step multiple times, the void ratio of the manufactured article can be decreased. Silicon carbide obtained by heat-treating the silicon carbide polymer at 400° C. or higher and 850° C. or lower has an amorphous structure. The properties can be improved by crystallization by subsequently performing heat treatment at 1,500° C. or higher and 1,600° C. or lower as necessary.

The manufactured article that underwent impregnation is subjected to a post process such as polishing and machining as necessary, as a result of which an article containing silicon carbide as a main component is obtained.

### Article (Three-Dimensional Manufactured Article)

An article according to an embodiment is a three-dimensional manufactured article manufactured by the article manufacturing method according to this embodiment. In addition, the article of this embodiment is a three-dimensional manufactured article manufactured by a powder bed fusion method or a binder jetting method using the raw material powder of this embodiment. The article of this embodiment can be used as, for example, a mechanical part such as a heat releasing part and a wear-resistant part. The mechanical part is constituted by a structure containing silicon carbide. As a result, a mechanical part having high strength can be realized. Various apparatuses can be configured by combining a mechanical part with at least one of an electrical part, an optical part, and a resin part. The apparatus can be a printing apparatus or an office appliance apparatus such as an inkjet printer, a laser printer, a scanner, a copier, and a multifunctional printer. The apparatus may be a video apparatus such as a camera, a display, or a projector. The apparatus may be an optical device such as an interchangeable lens or a binocular. The apparatus may be medical equipment such as an X-ray machine, a CT, an MRI, or an endoscope. The apparatus may be an industrial device such as an exposure device, a film deposition device, a power generator, or a robot. The apparatus may be any of various transfer apparatuses or transportation apparatuses such as an automobile, an airplane, and a ship. Furthermore, the apparatus may be a nuclear power reactor (a fusion reactor or a fission reactor), scientific equipment such as an accelerator, or space equipment such as a rocket or a satellite.

### EXAMPLES

### Example 1

### 1. Raw Material Powder 1

### (1) Preparation

A raw material powder was prepared by using the following powders as indicated in Table 1. Note that the number-average particle sizes and the aspect ratios indicated in Table 1 are values obtained by measuring the prepared raw material powder. The number-average particle size ratio indicated in Table 1 is metallic silicon particles/silicon carbide particles.
Silicon carbide particles (number-average particle size: 29.6 μm, aspect ratio: 0.80)
Metallic silicon particles (number-average particle size: 7.1 μm, aspect ratio: 0.73)
Inorganic material particles (composition: silicon dioxide, number-average particle size: 100 nm, aspect ratio: 0.90, surfaces were hydrophobized)

Silicon carbide particles, metallic silicon particles, and inorganic material particles were respectively weighed to 89.50 vol %, 10.00 vol %, and 0.50 vol % in terms of volume fraction in the raw material powder, so that the total was 10.0 kg. Here, the weighed values of the powders were calculated from the true density of each powder measured with a “dry-type automatic densitometer” (AccuPyc II 1340 produced by Shimadzu Corporation) and the desired volume fraction. The weighed powders were put in “V type blender (V20 produced by TOKUJU Co., LTD.) and mixed at a rotation rate of 30 rpm for 10 minutes to obtain a raw material powder 1.

### (2) Evaluation

### Laser Transmittance

The laser transmittance of the raw material powder was measured with a spectrophotometer (“U-4000” produced by Hitachi High-Tech Corporation). First, a glass transparent substrate having a recess 2 cm in diameter and 40 μm in depth was prepared, and baseline correction of the transparent substrate was performed with the spectrophotometer. Next, the raw material powder was put in the recess of the transparent substrate, the surface layer portion thereof was leveled to even-out the surface, and then the transparent substrate was loaded into the spectrophotometer to measure the transmittance for a wavelength of 1,060 nm. The result is indicated in Table 1.

### Flowability

The flowability of the raw material powder was evaluated through the angle of repose. The angle of repose was measured with “Powder Characteristics Tester” (PT-X produced by HOSOKAWA MICRON CORPORATION). By using a sieve with 150 μm openings, vibrations were applied until a pile formed on the table stabilized, and then the angle of repose was measured. The smaller the angle of repose, the better the flowability of the powder. The evaluation ratings were as follows. The result is indicated in Table 1.
AA: The angle of repose was smaller than 40°.
A: The angle of repose was 40° or greater but smaller than 45°.
B: The angle of repose was 45° or greater but smaller than 50°.
C: The angle of repose was 50° or greater.

### 2. Article 1-A

### (1) Preparation

A manufactured article was prepared as in the manufacturing method described with reference to FIGS. 2A to 2H. For manufacturing, “ProX DMP100” (produced by 3D Systems, Inc.) equipped with a 50 W fiber laser (beam diameter: 65 μm) was used.

First, N₂ gas was introduced into the machine to purge the inside with an N₂ atmosphere. As illustrated in FIGS. 2A and 2B, a roller 152 was used to level a raw material powder 101 on a SUS304 platform 130 to form a first raw material powder layer 102 having a thickness of 25 μm.

Next, as illustrated in FIG. 2C, the raw material powder layer 102 was irradiated with a 47.5 W laser while being scanned to generate a melt of the raw material powder 101 in a 5.0 mm×42.0 mm region and to thereby form a fused layer 100. It should be noted that, in order to decrease local temperature elevation and make the irradiation heat even within the manufacturing surface, dispersion laser irradiation was performed. Specifically, 1-mm square irradiation zones were set, and 0.1 mm overlaps were created between adjacent square irradiation zones with a center-to-center distance of 0.8 mm. Here, the laser scanning rate was set to 333 mm/s and the irradiation pitch was set to 40 μm.

Next, as illustrated in FIGS. 2D and 2E, a new raw material powder layer 102 having a thickness of 25 μm was formed over the surface of the fused layer 100, and the raw material powder layer 102 was irradiated with a laser while being scanned to generate a melt of the raw material powder 101 in a 5.0 mm×42.0 mm region and to thereby form a fused layer 100. Here, when two or more fused layers 100 were to be formed continuously, a subsequently formed fused layer 100 was rotated with respect to the previously formed fused layer 100 by an angle of 18° within the manufacturing plane while the irradiation zone was moved in parallel in a particular direction within the manufacturing surface by 0.25 mm. Due to these features, the temperature homogeneity within the manufacturing surface was assured, and a manufactured article having a relatively high strength could be obtained. These steps were repeated until the height of the fused layers 100 reached 4.0 mm, and ten 5.0 mm×42.0 mm×4.0 mm cuboid manufactured articles were prepared.

### Post Process Step

A sufficient amount of a phenolic resin (“PR-50607B” produced by Sumitomo Bakelite Co., Ltd.) was added to the obtained manufactured article dropwise, and then defoaming was performed in vacuum. After the excess phenolic resin on the manufactured article surface was wiped off, the phenolic resin was heated on a hot plate at 160° C. to be thermally cured. When a section of the phenolic resin-impregnated manufactured article was observed with a microscope, sufficient impregnation of the phenolic resin in the voids could be confirmed.

After the phenolic resin impregnation, the volume and weight of the manufactured article were measured, and the void ratio was calculated. Then the amount of metallic silicon suitable for impregnation was calculated from the calculated void ratio result. Alumina balls 2 mm in diameter were laid out as a setter on the bottom of an alumina crucible to prevent the manufactured article from contacting the crucible, and then the manufactured article was placed in the crucible. Thereon, metallic silicon fragments or a metallic silicon powder in an amount 20% larger than the calculated amount of metallic silicon was placed, and heat-treated. The heat treatment was performed in an N₂ atmosphere at a pressure of 2,000 Pa at 1,600° C. for 1 to 7 hours to obtain ten articles 1-A.

### (2) Evaluation

### Three-Point Flexural Strength

The flexural strength of the article was evaluated through a three-point flexural test in accordance with the JIS R 1601: Testing method for flexural strength of fine ceramics at room temperature.

Specifically, ten 5.0 mm×42.0 mm×4.0 mm cuboid articles 1-A were polished into 4.0 mm×40.0 mm×3.0 mm and used as evaluation samples. For each sample, 3×P×L/(2×w×t²) was calculated where P (N) represents the maximum load at break, L represents the distance between external supporting points and was 30 (mm), w represents the width of the sample piece and was 4 (mm), and t represents the thickness of the sample piece and was 3 (mm), and the average was obtained from the results and assumed to be the three-point flexural strength. The higher the value, the higher the strength. The evaluation ratings were as follows. The result is indicated in Table 2.
AA: The three-point flexural strength was 200 MPa or higher.
A: The three-point flexural strength was 190 MPa or higher but lower than 200 MPa.
B: The three-point flexural strength was 170 MPa or higher but lower than 190 MPa.
C: The three-point flexural strength was lower than 170 MPa.

### 3. Article 1-B

### (1) Preparation

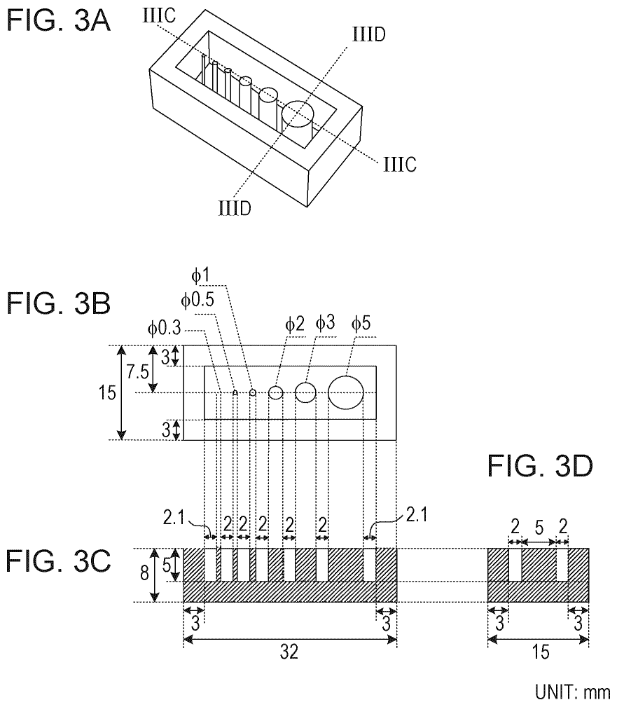

One article 1-B illustrated in FIGS. 3A to 3D was obtained as with the article 1-A except that the post process step of impregnation with a phenolic resin and metallic silicon was omitted. FIGS. 3A to 3D illustrate the article 1-B as the sample for evaluating delamination, in which FIG. 3A is a perspective view, FIG. 3B is a top view, FIG. 3C is a cross-sectional view taken at line IIIC-IIIC in FIG. 3A, and FIG. 3D is a cross-sectional view taken at line IIID-IIID in FIG. 3A. As illustrated in FIGS. 3A to 3D, the article 1-B has 5.0 mm-high columns respectively having diameters of 0.3 mm, 0.5 mm, 1.0 mm, 2.0 mm, 3.0 mm, and 5.0 mm.

### (2) Evaluation

### Delamination

Delamination was evaluated by whether the article 1-B could be manufactured. Specifically, the article 1-B was visually evaluated in terms of the diameters of the columns that could be manufactured without collapsing. A column with a smaller diameter is more susceptible to the influence of delamination. Thus, the ability to manufacture columns with smaller diameters indicates less delamination. The evaluation ratings were as follows. The result is indicated in Table 2.
AA: Columns having a diameter of 0.3 mm or more could be manufactured.
A: Columns having a diameter of 0.5 mm or more could be manufactured.
B: Columns having a diameter of 1.0 mm or more could be manufactured.
C: Columns having a diameter of 2.0 mm or more could be manufactured.

### Examples 2 to 24 and Comparative Examples 1 to 4

### 1. Raw Material Powder

Raw material powders 2 to 24 were obtained as with the raw material powder 1 except that the types and amounts of silicon carbide particles, metallic silicon particles, and inorganic material particles were changed as indicated in Table 1, and evaluation was conducted as with the raw material powder 1. The result is indicated in Table 1. Note that the inorganic material particles in the raw material powder 16 contained inorganic material particles having a particle size of 200 nm or less.

2. Article

Articles 2-A to 24-A and articles 2-B to 24-B were prepared by using the raw material powders 2 to 24 as with the particles 1-A and 1-B, and the evaluation was conducted as with the articles 1-A and 1-B. The result is indicated in Table 2.

TABLE 1

| | | | | Number-average | | Number- | | |
|---|---|---|---|---|---|---|---|---|
| | Volume fraction [vol %] | | | particle size [μm] | | average | Aspect ratio | |
| Raw | Silicon | Metallic | Inorganic | Silicon | Metallic | particle | Silicon | Metallic |
| material | carbide | silicon | material | carbide | silicon | size | carbide | silicon |
| powder | particles | particles | particles | particles | particles | ratio | particles | particles |
| 1 | 89.50 | 10.00 | 0.50 | 29.6 | 7.1 | 0.240 | 0.80 | 0.73 |
| 2 | 89.50 | 10.00 | 0.50 | 29.6 | 7.1 | 0.240 | 0.80 | 0.73 |
| 3 | 89.50 | 10.00 | 0.50 | 15.1 | 3.7 | 0.245 | 0.72 | 0.70 |
| 4 | 89.50 | 10.00 | 0.50 | 48.5 | 11.1 | 0.229 | 0.80 | 0.65 |
| 5 | 89.50 | 10.00 | 0.50 | 2.3 | 0.5 | 0.217 | 0.73 | 0.68 |
| 6 | 89.50 | 10.00 | 0.50 | 96.7 | 20.0 | 0.207 | 0.78 | 0.74 |
| 7 | 89.50 | 10.00 | 0.50 | 29.6 | 0.8 | 0.027 | 0.80 | 0.73 |
| 8 | 89.50 | 10.00 | 0.50 | 29.6 | 17.2 | 0.581 | 0.80 | 0.74 |
| 9 | 89.50 | 10.00 | 0.50 | 29.6 | 23.0 | 0.777 | 0.80 | 0.74 |
| 10 | 89.50 | 10.00 | 0.50 | 29.6 | 0.3 | 0.010 | 0.80 | 0.73 |
| 11 | 89.50 | 10.00 | 0.50 | 29.6 | 27.5 | 0.929 | 0.80 | 0.75 |
| 12 | 96.50 | 3.00 | 0.50 | 29.6 | 7.1 | 0.240 | 0.80 | 0.73 |
| 13 | 74.60 | 24.90 | 0.50 | 29.6 | 7.1 | 0.240 | 0.80 | 0.73 |
| 14 | 55.70 | 43.80 | 0.50 | 29.6 | 7.1 | 0.240 | 0.80 | 0.73 |
| 15 | 89.50 | 10.50 | — | 29.6 | 7.1 | 0.240 | 0.80 | 0.73 |
| 16 | 89.50 | 10.00 | 0.50 | 29.6 | 7.1 | 0.240 | 0.80 | 0.73 |
| 17 | 86.92 | 9.70 | 3.38 | 29.6 | 7.1 | 0.240 | 0.80 | 0.73 |
| 18 | 89.50 | 10.00 | 0.50 | 29.6 | 7.1 | 0.240 | 0.80 | 0.73 |
| 19 | 89.50 | 10.00 | 0.50 | 29.6 | 7.1 | 0.240 | 0.80 | 0.73 |
| 20 | 89.50 | 10.00 | 0.50 | 28.4 | 6.9 | 0.243 | 0.55 | 0.50 |
| 21 | 89.50 | 10.00 | 0.50 | 29.6 | 8.5 | 0.287 | 0.80 | 0.84 |
| 22 | 98.50 | 1.00 | 0.50 | 96.7 | 75.0 | 0.776 | 0.78 | 0.73 |
| 23 | 59.70 | 39.80 | 0.50 | 96.7 | 0.8 | 0.008 | 0.78 | 0.73 |
| 24 | 60.00 | 40.00 | — | 96.7 | 0.8 | 0.008 | 0.78 | 0.84 |
| 25 | 99.50 | 0.00 | 0.50 | 29.6 | — | — | 0.80 | — |
| 26 | 89.50 | 10.00 | 0.50 | 29.6 | 45.0 | 1.520 | 0.80 | 0.72 |
| 27 | 89.50 | 10.00 | 0.50 | 2.3 | 3.7 | 1.609 | 0.73 | 0.70 |
| 28 | 89.50 | 10.00 | 0.50 | 96.7 | 120.0 | 1.241 | 0.78 | 0.69 |

| Raw | Inorganic material particles | | | | Laser | |
|---|---|---|---|---|---|---|
| material | | Number-average | Surface | Aspect | transmittance | Flowability |
| powder | Composition | particle size [nm] | hydrophobizing | ratio | [%] | evaluation |
| 1 | SiO₂ | 100 | Yes | 0.90 | 35.2 | AA |
| 2 | Al₂O₃ | 100 | Yes | 0.90 | 36.8 | AA |
| 3 | SiO₂ | 100 | Yes | 0.90 | 38.2 | AA |
| 4 | SiO₂ | 100 | Yes | 0.90 | 33.0 | AA |
| 5 | SiO₂ | 100 | Yes | 0.90 | 44.8 | B |
| 6 | SiO₂ | 100 | Yes | 0.90 | 24.2 | AA |
| 7 | SiO₂ | 100 | Yes | 0.90 | 45.0 | AA |
| 8 | SiO₂ | 100 | Yes | 0.90 | 30.2 | AA |
| 9 | SiO₂ | 100 | Yes | 0.90 | 24.2 | AA |
| 10 | SiO₂ | 100 | Yes | 0.90 | 46.8 | B |
| 11 | SiO₂ | 100 | Yes | 0.90 | 22.3 | AA |
| 12 | SiO₂ | 100 | Yes | 0.90 | 30.3 | AA |
| 13 | SiO₂ | 100 | Yes | 0.90 | 41.4 | AA |
| 14 | SiO₂ | 100 | Yes | 0.90 | 46.4 | AA |
| 15 | No | — | — | — | 46.9 | B |
| 16 | SiO₂ | 210 | Yes | 0.90 | 40.4 | A |
| 17 | SiO₂ | 100 | Yes | 0.90 | 44.2 | A |
| 18 | SiO₂ | 100 | No | 0.90 | 41.0 | A |
| 19 | SiO₂ | 100 | Yes | 0.80 | 37.4 | B |
| 20 | SiO₂ | 100 | Yes | 0.90 | 39.8 | B |
| 21 | SiO₂ | 100 | Yes | 0.90 | 37.0 | A |
| 22 | SiO₂ | 100 | Yes | 0.90 | 20.4 | A |
| 23 | SiO₂ | 100 | Yes | 0.90 | 49.8 | A |
| 24 | No | — | — | — | 54.8 | B |
| 25 | SiO₂ | 100 | Yes | 0.90 | 2.0 | AA |
| 26 | SiO₂ | 100 | Yes | 0.90 | 14.2 | AA |
| 27 | SiO₂ | 100 | Yes | 0.90 | 15.3 | B |
| 28 | SiO₂ | 100 | Yes | 0.90 | 8.3 | AA |

TABLE 2

| | | Three-point | |
|---|---|---|---|
| | | flexural | |
| | Raw material powder | strength | Delamination |
| Example 1 | Raw material powder 1 | AA | AA |
| Example 2 | Raw material powder 2 | AA | AA |
| Example 3 | Raw material powder 3 | AA | AA |
| Example 4 | Raw material powder 4 | AA | AA |
| Example 5 | Raw material powder 5 | AA | AA |
| Example 6 | Raw material powder 6 | A | A |
| Example 7 | Raw material powder 7 | AA | AA |
| Example 8 | Raw material powder 8 | AA | AA |
| Example 9 | Raw material powder 9 | A | AA |
| Example 10 | Raw material powder 10 | AA | AA |
| Example 11 | Raw material powder 11 | B | A |
| Example 12 | Raw material powder 12 | AA | AA |
| Example 13 | Raw material powder 13 | AA | AA |
| Example 14 | Raw material powder 14 | B | AA |
| Example 15 | Raw material powder 15 | A | A |
| Example 16 | Raw material powder 16 | AA | AA |
| Example 17 | Raw material powder 17 | AA | AA |
| Example 18 | Raw material powder 18 | AA | AA |
| Example 19 | Raw material powder 19 | AA | A |
| Example 20 | Raw material powder 20 | A | AA |
| Example 21 | Raw material powder 21 | A | AA |
| Example 22 | Raw material powder 22 | B | B |
| Example 23 | Raw material powder 23 | B | B |
| Example 24 | Raw material powder 24 | B | B |
| Comparative | Raw material powder 25 | C | C |
| Example 1 | | | |
| Comparative | Raw material powder 26 | C | C |
| Example 2 | | | |
| Comparative | Raw material powder 27 | C | C |
| Example 3 | | | |
| Comparative | Raw material powder 28 | C | C |
| Example 4 | | | |

As the mechanism described above, the effects of the technology as indicated in the present disclosure can be achieved by the synergetic effects of the individual features described above.

The technology according to the present disclosure is not limited by the embodiments and examples described above, and numerous modifications and alterations are possible within the technical concept of the present disclosure. Furthermore, the effects indicated in the embodiments and examples of the technology according to the present disclosure are only some of the effects of the present disclosure, and are not limited to those described in the embodiments and examples above.

Moreover, new subject matter can be additionally introduced to at least one of the embodiments. The contents of the disclosure of the present specification include not only those explicitly disclosed in the present specification but also all matters that are comprehensible from the present specification and the drawings attached to the present specification.

Regarding specific numerical ranges indicated as examples in the present specification, the notation “e to f” (where e and f each represent a number) means “e or more and/or f or less”. Furthermore, regarding any specific numerical range indicated as an example, if a range of i to j and a range of m to n (where i, j, m, and n each represent a number) are both described, the combination of the lower limit and the upper limit is not limited to the combination of i and j or the combination of m and n. For example, the lower limit and upper limit of multiple combinations can be combined. That is, when a range of i to j and a range of m to n are both described, a range of i to n may be studied and/or a range of m to j may be studied as long as no contradiction arises. Furthermore, “e or more” means e or larger than e (exceeding e), and a value larger than e may be employed instead of e. In addition, “f or less” means f or smaller than f (less than f), and a value smaller than f may be employed instead of f.

The contents of the disclosure of the present specification include complementary sets of individual concepts described in the present specification.

That is, for example, a phrase “A is B” in the specification is considered as that the present specification also discloses “A is not B” although the indication that the “A is not B” is omitted. This is because when there is a phrase “A is B”, the presumption is that the case in which “A is not B” is taken into account.

The present disclosure provides a technology advantageous in manufacturing articles having excellent strength.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-049551, filed Mar. 26, 2024, which is hereby incorporated by reference herein in its entirety.

What is claimed is:

1. A method for manufacturing an article containing silicon carbide as a main component, the method comprising:
a step of forming a layer of a material powder; and
a step of irradiating the layer of the material powder with a laser on the basis of data from a three-dimensional model,
wherein
the steps are performed multiple times
the material powder contains
silicon carbide particles having a particle size larger than 200 nm, and
metallic silicon particles having a particle size larger than 200 nm, and
the metallic silicon particles have a number-average particle size smaller than a number-average particle size of the silicon carbide particles.

2. The method according to claim 1, wherein the number-average particle size of the silicon carbide particles is 2.0 μm or more and 100.0 μm or less.

3. The method according to claim 1, wherein a ratio of the number-average particle size of the metallic silicon particles to the number-average particle size of the silicon carbide particles is 0.005 or more and 0.950 or less.

4. The method according to claim 1, wherein a volume fraction of the silicon carbide particles relative to the material powder is 55.00 vol % or more and 95.00 vol % or less.

5. The method according to claim 1, wherein a volume fraction of the silicon carbide particles relative to the material powder is 75.00 vol % or more and 95.00 vol % or less.

6. The method according to claim 1, wherein the silicon carbide particles have an aspect ratio of 0.60 or more and 1.00 or less.

7. The method according to claim 1, wherein the silicon carbide particles have an aspect ratio larger than an aspect ratio of the metallic silicon particles.

8. The method according to claim 1, wherein the material powder further contains inorganic material particles that satisfy at least one of having a particle size of 200 nm or less and being composed of an inorganic material other than silicon carbide and metallic silicon.

9. The method according to claim 8, wherein a volume fraction of the inorganic material particles relative to the material powder is 0.01 vol % or more and 4.00 vol % or less.

10. The method according to claim 8, wherein the inorganic material constituting the inorganic material particles is an inorganic oxide, an inorganic nitride, or an inorganic carbide.

11. The method according to claim 8, wherein the inorganic material particles have hydrophobized surfaces.

12. The method according to claim 8, wherein the inorganic material particles have an aspect ratio of 0.85 or more and 1.00 or less.

13. The method according to claim 8, wherein the inorganic material particles have a number-average particle size of 3 nm or more and 200 nm or less.

14. The method according to claim 1, wherein the layer of the material powder has a transmittance of 20.0% or more 50.0% or less for the laser.

15. An apparatus comprising:
a mechanical part being an article manufactured by the method according to claim 1; and
at least one of an electrical part, an optical part, and a resin part.

16. A powder material for use in a powder bed fusion method or a binder jetting method, the powder material comprising:
silicon carbide particles having a particle size larger than 200 nm; and
metallic silicon particles having a particle size larger than 200 nm,
wherein the metallic silicon particles have a number-average particle size smaller than a number-average particle size of the silicon carbide particles.

17. The powder material according to claim 16, wherein the powder material satisfies at least one of conditions comprising:
a first condition wherein a 40 μm-thick layer of the powder material has a transmittance of 20.0% or more and 50.0% or less for a laser having a wavelength of 1,060 nm;
a second condition wherein the number-average particle size of the silicon carbide particles is 2.0 μm or more and 100.0 μm or less;
a third condition wherein a ratio of the number-average particle size of the metallic silicon particles to the number-average particle size of the silicon carbide particles is 0.005 or more and 0.950 or less;
a fourth condition wherein a volume fraction of the silicon carbide particles relative to the powder material is 55.00 vol % or more and 95.00 vol % or less;
a fifth condition wherein the silicon carbide particles have an aspect ratio of 0.60 or more and 1.00 or less; and
a sixth condition wherein the silicon carbide particles have an aspect ratio larger than an aspect ratio of the metallic silicon particles.

18. The powder material according to claim 16, further comprising inorganic material particles that satisfy at least one of having a particle size of 200 nm or less and being composed of an inorganic material other than silicon carbide and metallic silicon.

19. The powder material according to claim 18, wherein a volume fraction of the inorganic material particles relative to the powder material is 0.01 vol % or more and 4.00 vol % or less, and/or, wherein the inorganic material constituting the inorganic material particles is an inorganic oxide, an inorganic nitride, or an inorganic carbide.

20. A three-dimensional manufactured article manufactured by a powder bed fusion method or a binder jetting method using the powder material according to claim 16.

21. A powder material comprising:
silicon carbide particles having a particle size larger than 200 nm;
metallic silicon particles having a particle size larger than 200 nm; and
inorganic material particles that satisfy at least one of having a particle size of 200 nm or less and being composed of an inorganic material other than silicon carbide and metallic silicon,
wherein the metallic silicon particles have a number-average particle size smaller than a number-average particle size of the silicon carbide particles,
the inorganic material constituting the inorganic material particles is an inorganic oxide, an inorganic nitride, or an inorganic carbide, and
a volume fraction of the inorganic material particles relative to the powder material is 0.01 vol % or more and 4.00 vol % or less.

22. The powder material according to claim 21,
wherein the inorganic material particles have hydrophobized surfaces, and/or
wherein the inorganic material particles have an aspect ratio of 0.85 or more and 1.00 or less, and/or
wherein the inorganic material particles have a number-average particle size of 3 nm or more and 200 nm or less.
